(19) United States
(12) Patent Application Publication
(10) Pub. No.: US 2007/0012375 A1
(43) Pub. Date: Jan. 18, 2007

(54) Waste-liquid transfer apparatus and method

(75) Inventors: William P. Fannon III, Phoenix, MD (US); Mical Mershon, Dundalk, MD (US)

Correspondence Address: BIRCH STEWART KOLASCH & BIRCH, PO BOX 747, FALLS CHURCH, VA, 22040-0747, US

(73) Assignee: Waste Control Systems, Inc.

(21) Appl. No.: 11/401,890

(22) Filed: Apr. 12, 2006

Related U.S. Application Data
(60) Provisional application No. 60/698,483, filed on Jul. 13, 2005.

(51) Int. Cl. B67C 3/02

(52) U.S. Cl. 141/67

(57) ABSTRACT

A waste liquid transfer apparatus and method includes a liquid pump driven by pressurized gas connected to collection and discharge lines that respectively extend into collection and discharge containers. The pressurized gas is also applied to the waste liquid for otherwise enhancing orderly transfer of the waste liquid from the collection container to the discharge container. Valves are switched for deactivating the pump and causing the pressurized gas to flow through the collection line, thereby flushing the collection line and agitating liquid to be collected. The collection line includes a collection wand having a removable strainer at the top thereof that is simultaneously purged by the back-flushing pressurized gas. Pressurized gas is used to measure liquid level in the discharge container and to turn off the pump when the discharge container is full.

This non-provisional application claims priority under 35 U.S.C. §119(e) of Provisional Application No. 60/698,483, filed on Jul. 13, 2005, which is incorporated herein by reference.

### BACKGROUND OF THE INVENTION

This invention relates generally to the art of liquid waste management and more specifically, to apparatus and methods for transferring waste liquids from collection containers to discharge, or disposal, containers.

Quite often in laboratories, factories, hospitals, research facilities, and the like, large amounts of waste liquids, often dangerous, are generated. These waste liquids are often accumulated in relatively small collection containers distributed throughout a facility. Periodically, these collection containers are brought to a common disposal area where they are emptied into discharge, or disposal, containers, such as 55-gallon drums. In the prior art, contents of the collection containers have frequently been poured, either directly or with funnels, into the discharge containers. Although the collection containers are relatively small, they can weigh as much as 60 lbs. and must be lifted to shoulder height for pouring into 55-gallon drums. Thus, pouring such collections containers can be quite hazardous to technicians because of side spills, burping funnels, overfill spills, and the like. Even when these pouring procedures are carried out without spills, technicians are at risk from fumes of the liquid waste. Because of dangers inherent in pouring chemicals, solvents, and other liquid wastes from one container to another, technicians handling these wastes often are required to employ extensive personal protective equipment, and use forced-air breathing apparatus and respirators.

Thus, it is an object of this invention to provide an apparatus and a process for transferring waste liquids from collection containers to larger discharge containers with a reduced risk from waste liquid and fumes escaping and thereby endangering technicians.

Similarly, it is an object of this invention to provide an apparatus and a process for transferring waste liquids that do not require the use of such extensive protective equipment.

A difficulty in providing a mechanized method and apparatus for transferring solvents, and other waste liquids, between containers is that such apparatus normally increase the possibility of explosion or fire caused by electrical corona discharges from equipment. It is therefore an object of this invention to provide a non-pouring, mechanized, apparatus and method for transferring waste liquid between containers that minimize the risk of explosions and fires.

### SUMMARY OF THE INVENTION

According to principles of this invention, a waste liquid transfer apparatus and method includes a liquid pump driven by pressurized gas, such as air, connected to collection and discharge lines that respectively extend into collection and discharge containers. The pressurized gas is additionally applied to the waste liquid for enhancing orderly transfer of the waste liquid from the collection container to the discharge container. In a preferred embodiment, the liquid pump is a diaphragm pump that is turned on by moving a valve to allow pressurized air to drive the pump.

When necessary, valves can be switched for deactivating the pump and causing the pressurized gas to flow through the collection line, thereby back flushing the collection line and agitating liquid and suspended solids in the collection container. The collection line includes a rigid collection wand having a linear portion with a strainer at top end thereof that is simultaneously purged by the back-flushing pressurized gas.

The pressurized gas is also used to monitor a level of waste liquid in the discharge drum by applying pressurized gas to a level-sensor wand in the discharge drum and monitoring pressure in the level-sensor wand. When the level of waste liquid in the discharge drum reaches a predetermined level, pressure in the level-sensor wand also reaches a predetermined level, which pressure is used to turn off flow of pressurized gas to the diaphragm pump, thereby stopping the pump and the transfer of liquid waste. The apparatus includes a common bung fitting for the discharge container in which are mounted both the discharge wand and the level-sensor wand. Further, an accumulator is included between the diaphragm pump and the discharge wand for smoothing flow and thereby reducing splash.

The waste liquid transfer apparatus includes a housing for the diaphragm pump having a holster for receiving the various wands when they are not inserted in collection and discharge containers, grounding wires, and, in one embodiment, wheels.

### BRIEF DESCRIPTION OF THE DRAWINGS

The invention is explained and described in more detail below using embodiments shown in the drawings. The described and drawn features, in other embodiments of the invention, can be used individually or in preferred combinations. The foregoing and other objects, features, and advantages of the invention will be apparent from the following more particular description of the preferred embodiments of the invention, as illustrated in the accompanying drawings, in which reference characters refer to the same parts throughout the different views. The drawings are not necessarily to scale, emphasis instead being placed on illustrating principles of the invention in a clear manner.

FIG. 1 is a partially cut-away schematic view of one embodiment of a waste-liquid transfer apparatus of this invention, shown with collection containers and a discharge drum;

FIG. 2 is an isometric view of a second embodiment waste-liquid transfer apparatus of this invention with a collection container and a discharge drum;

FIG. 3 is a schematic diagram of a waste-liquid transfer apparatus, with a collection container and a discharge drum, of this invention when it is in an “off” mode;

FIG. 4 is a schematic diagram similar to FIG. 3, but when the waste-liquid transfer apparatus is in an “on” mode for transferring waste liquids;

FIG. 5 is a schematic diagram similar to FIGS. 3 and 4, but with the waste-liquid transfer apparatus in a “back-flush/agitation” mode; and

FIG. 6 is a schematic diagram similar to FIGS. 3, 4, and 5, but with the waste-liquid transfer apparatus in a “level-sensing off” mode in which it has been automatically turned off by a full discharge container.

### DESCRIPTION OF A PREFERRED EMBODIMENT

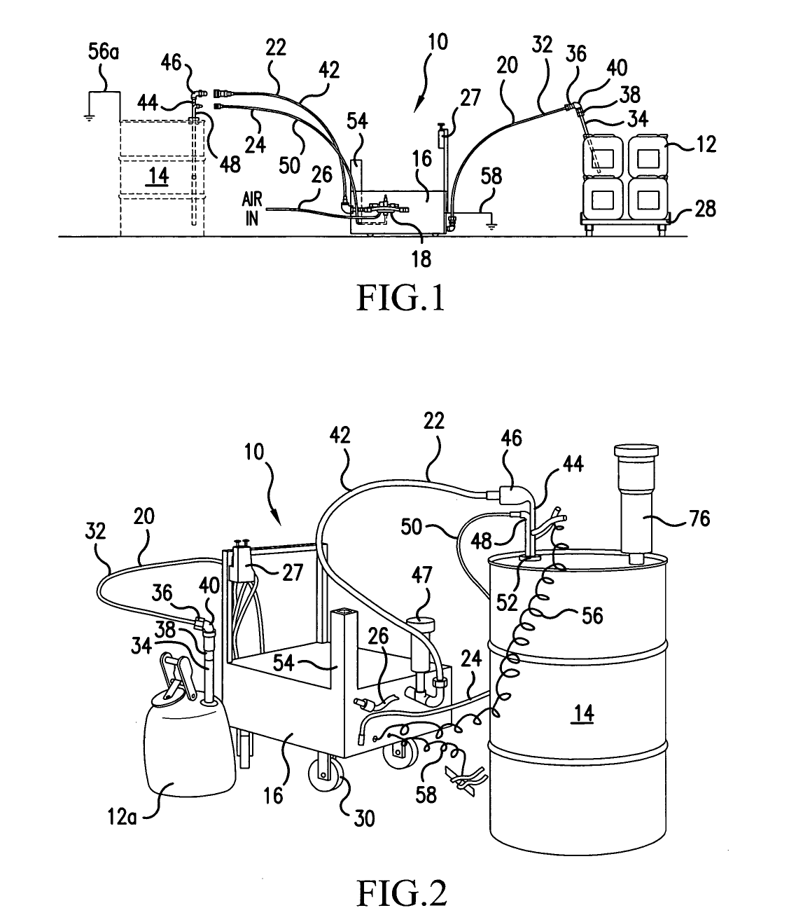

With reference to FIG. 1, a waste-liquid transfer apparatus 10 of this invention for transferring waste liquids from portable collection containers 12 to a discharge drum 14 includes a housing 16 having a air-pressure-driven diaphragm pump 18 therein that is interconnected with a collection line 20, a discharge line 22, a liquid-level sensor line 24, an air-in line 26, and various air control valves 27.

Regarding the collection containers 12, these can be of various sizes, from 1 liter up to 6 gallons. They could be constructed of plastic, metal, or glass, depending on chemicals that they hold. The predominant material is polyethylene and the most common size is 5-gallons. The collection containers 12 depicted in FIG. 1 are indeed 5-gallon collection containers that are transported on a cart 28 having wheels. The collection container 12a of FIG. 2 is somewhat smaller and has an over-center clamped closure. These collection container systems are currently used in the prior art.

The collection containers 12 and 12a can contain almost any waste liquids, including chemicals, solvents, or aqueous solutions, with many such liquids also having solid residue therein, such as organic tissue.

Transport carts, such as cart 28, may vary with each institution depending on a choice of containers and a manner in which containers are handled. The cart 28 shown in FIG. 1 holds twenty 5-gallon containers 12.

Similarly, the discharge, disposal, or consolidation drum 14 can be of any type, however, quite often it is a standard 17H 55-gallon steel drum having two bung holes, at least one of them being a 2 inch FNPT bung opening.

In the embodiment of FIG. 1, the housing 16 is shown as stationary, whereas in the embodiment of FIG. 2, it is on wheels 30.

The diaphragm pump 18 is driven by pressurized gas, namely pressurized air, coming in through the air-in line 26. For example, Wilden Pump and Engineering, LLC, of Grand Terrace, California, sells a double-diaphragm pump that works particularly well in this invention under the mark PROFLO™ Wilden Diaphragm Pump. Basically, when pressurized air is applied to the pump an air valve spool oscillates back and forth to cause alternate high and low pressures on opposite sides of diaphragms so that the diaphragms move back and forth for alternately sucking liquid into and depressing the liquid from chambers on opposite sides of the diaphragms. Check valves are positioned at inlets and outlets of the chambers to ensure liquid flows in the correct directions. A significant aspect of this diaphragm pump is that it is totally operated by pressurized gas; that is, it is pneumatically operated. When pressurized air is applied to the pump, the diaphragms are moved back and forth for alternately sucking liquid in through liquid-inlet check valves and pushing it out through outlet check valves. When the pressurized air is cut off, the pump ceases to pump liquid.

Looking in more detail at the collection line 20, this line includes a flexible tube 32 and a rigid suction wand 34 that is attached thereto at 36. The suction wand 34 includes in a linear portion thereof a strainer 38 that is generally below a 90-degree elbow 40, the purpose of which will be described below.

The discharge line 22 includes a flexible tube 42 and a rigid discharge wand 44. The discharge wand 44 also includes a 90-degree elbow at an upper end portion thereof having a quick disconnect 46 for attaching to the flexible tube 42. An accumulator 47 is connected to the discharge line 22 for smoothing pressure surges and thereby smoothing flow through the discharge line 22, which reduces splash as well as mechanical pulsations.

The liquid-level sensor line 24 similarly comprises a rigid level-sensor wand 48 and a flexible level-sensor tube 50.

The rigid discharge and level-sensor wands 44 and 48 are mounted in a bung assembly 52. The bung assembly 52 is similar to a normal bung-hole cover that screws into the two inch bung opening on the discharge drum 14. The bung assembly allows liquid and air to pass into the drum through the discharge and level-sensing wands 44 and 48, respectively, while otherwise sealing the bung opening.

The valves 27, and controls thereof, will be described in more detail below with a description of operation of the waste-liquid transfer apparatus of this invention.

The housing 16 has a holster 54 for receiving the suction, discharge, and level-sensing wands 34, 44, 48 when these wands are not inserted into collection and discharge containers. This housing serves as a secondary containment to capture liquids draining from the wands.

The waste-liquid transfer apparatus 10 further includes grounding wires and clamps 56 and 58 for preventing corona discharges from either the waste-liquid transfer apparatus 10 and/or the discharge drum 14. In the FIG. 1 embodiment, there is an independent ground 56a attached to the discharge drum 14 while in the FIG. 2 embodiment the waste-liquid transfer apparatus includes the ground 56 extending to the discharge drum 14, and the true ground 58 for attaching to an outside ground, such as a building pipe. Various grounding arrangements can be used.

The waste-extraction, or suction, wand 34 serves several purposes. A primary function is to remove waste liquids from the collection containers 12. This suction wand can be longer for pumping out a 55-gallon drum when it is necessary to evacuate such a drum, for example if the drum is damaged. A secondary function of the suction wand 34 is to inject air into the waste liquid for agitating solids therein that have settled to the bottom so that they will be suspended in the liquid and can be pumped off with the liquid. This is particularly useful with formalin solutions with blood and organic tissue products. This agitation simultaneously functions as a back-flush circuit to clear any blockages in the suction wand 34. This procedure will be further described with the description of operation of the waste-liquid transfer apparatus below.

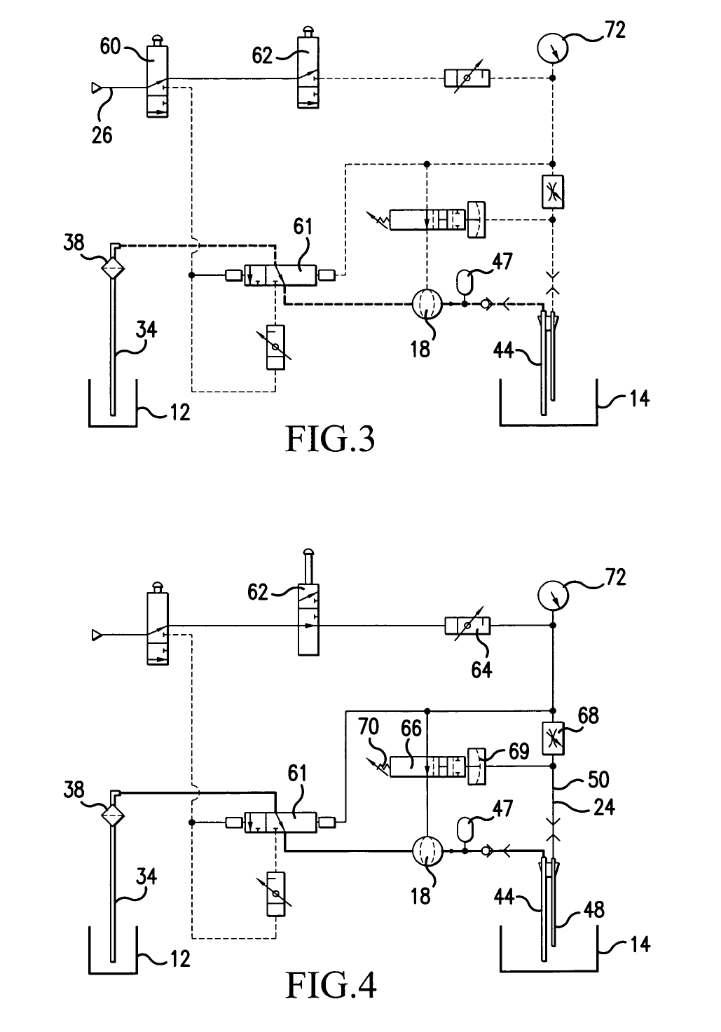

The manually operated valves 27 include a back-flush control valve 60 (FIGS. 3-6) and a start valve 62. The operation and purpose of these valves, as well as other valves, various regulators, flow controllers and the like, will be described along with operation of the waste-liquid transfer apparatus 10 in conjunction with FIGS. 3-6.

Looking now at operation of the waste-liquid transfer apparatus 10, FIG. 3 depicts an “off” operational mode in which the diaphragm pump 18 is turned off, although the suction and discharge wands 34 and 44 are respectively in the collection container 12 and the discharge drum 14. That is, the diaphragm pump 18 is not pumping liquid from the collection container 12 to the discharge drum 14 because the diaphragm pump 18 has no pressurized air applied to it. In this regard, the start valve 62 is manually positioned such that it does not allow passage of pressurized air from the air-inline 26 to the diaphragm pump 18. In FIGS. 3-6, solid lines indicate flow, dashed lines indicate lines that have no flow, thicker lines indicate liquid lines and thinner lines indicate airlines.

FIG. 4 indicates an “on” mode of operation in which the start valve 62 has been manually moved to a position for allowing airflow to the diaphragm pump 18 via an air regulator 64 and a level-control valve 66. The air regulator 64 can be manually set to control airflow for providing a desired speed of operation of the diaphragm pump 18 while the level-control valve 66 will automatically stop air flow to the pump 18 when liquid level in the discharge drum 14 reaches a predetermined level as will be described in conjunction with FIG. 6 below. In this regard, however, it should be noted in FIG. 4 that pressurized air is fed to the level-sensor wand 48 via a flow control 68 and this pressurized air is blown into waste liquid in the discharge drum 14. However, the liquid level is not sufficiently high in the discharge drum to increase pressure in the level sensor line 24 for causing a diaphragm 69 of the level-control valve 66 to overcome a spring 70 and thereby cut off the level-control valve 66. It should be further noted that in this “on” mode, a pressure gauge 72 provides a substantial pressure reading, whereas in the FIG. 3 “off” mode the pressure gauge 72 shows zero pressure. Thus, in this “on” mode, the diaphragm pump 18 is driven by pressurized air to suck liquid from the collection container 12 via the suction wand 34, the strainer 38, and the back-flush valve 61 and to inject this waste liquid through the discharge wand 44 into the discharge drum 14. Some waste liquid will also temporarily go into the accumulator 47, which will smooth-out pressure surges and flow and thereby reduce splashing of liquid being ejected from the discharge wand 44.

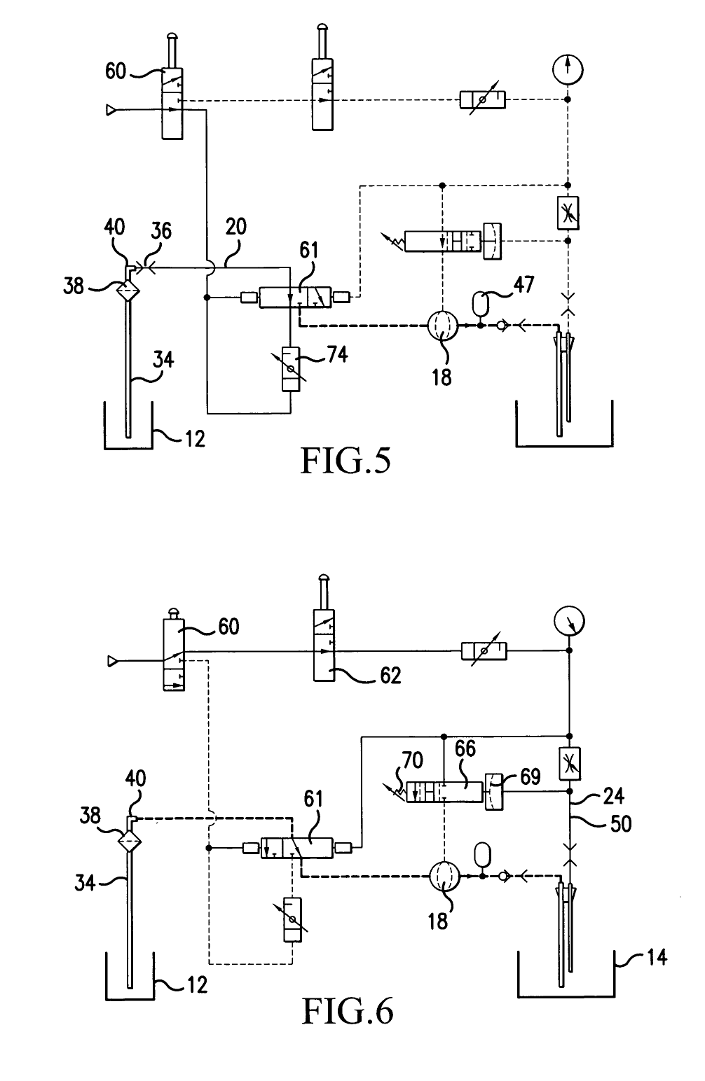

FIG. 5 depicts a “back-flush/agitation” mode of the waste-liquid transfer apparatus of this invention in which the back-flush control valve 60 has been manually moved to a position for diverting pressurized air away from the diaphragm pump 18. In this mode, when the back-flush control valve 60 is manually moved, differential pressure on opposite sides of the back-flush valve 61 pilots it to a position in which it cuts off liquid flow (although the diaphragm pump 18 is also turned off) and allows retrograde pressurized air flow through a regulator. 74 and the suction wand 34, including the strainer 38. The regulator 74 can be set to provide a desired flow of pressurized air. This compressed air simultaneously agitates the liquid waste in the collection container 12 and back-flushes substantially everything on the extraction side of the diaphragm pump 18. It should be noted that the stainless steel strainer 38 has a number 12 mesh which prevents particles of greater than 1/16 inch from passing. The strainer 38 thus protects the pump 18. By positioning the strainer 38 below the elbow 40, the suction wand 34 can sometimes just be tapped to dislodge contaminants in the strainer via mechanical force. This comes about when there are small magnetic/ceramic stirrers in the waste stream. If such mechanical forces do not dislodge the blockage, the “back-flush/agitation” mode of FIG. 5 can be initiated and the contaminants can be washed out by pressurized flow of liquid contained in the collection line 20 between the back-flow valve 61 and the strainer 38. Such flushing is primarily used to remove animal and human tissues as well as other biological materials (agar and growth medias). If the liquid passes without clearing the strainer 38, then pressurized air follows, which will normally remove contaminants from the strainer. It is necessary to back-flush with air usually when there are filter papers or labels in the waste material. The air regulator 74 is set low, 5-7 psi, so as not to splash an operator, but the capability is present to adjust this air pressure to whatever pressure is supplied at the air-inline 26. This can be field-adjusted to suit a specific application. If all of these procedures fail to clear the blockage, the strainer 38 can be disassembled and manually cleaned.

FIG. 6 depicts a “level-sensing off” mode of the waste-liquid transfer apparatus. In this mode, it is noted that, since the strainer 38 has been cleaned, the back-flush control valve 60 has been moved back to its manual “on” position, and the back-flush valve 61 is thereby piloted to a liquid-flow position by an air-pressure differential across it. This allows pressurized airflow through the start valve 62 toward the diaphragm pump 18. But in the “liquid-sensing off” mode, pressurized air in the level-sensor tube 50 is caused to rise by the level of liquid waste in the discharge drum 14, so as to cause a diaphragm 69 to move the level control valve 66 against a spring 70 to thereby turn off flow of pressurized air to the diaphragm pump 18. Thus, the diaphragm pump 18 is turned off and no further waste liquid is pumped from the collection container 12 to the discharge drum 14.

The waste-liquid transfer apparatus of this invention is entirely operated with pressurized air. Further, all components in contact with waste liquids are either stainless steel or PTFE TEFLON. Further, there is a minimum of metal-on-metal movement. Thus, spark and fire risks are reduced. A pressurized air supply, from a building for example, is used for driving and controlling the waste-liquid transfer apparatus of this invention.

The storage holster 54 holds both the bung assembly 52 (with the attached discharge wand 44 and the level-sensor wand 48) and the suction wand 34 when these items are not in use. The storage holster 54 has a secondary containment to collect chemicals that will drip once these items are removed from the drum 14 and the collection container 12, respectively. There is an area therein to place absorbent materials to collect these residue liquids.

There are check valves on both sides of the various quick-disconnect fittings on the discharge line to prevent leakage when disconnected. Thus, these fittings will not allow liquids to pass unless they are connected. Further, the quick-disconnect fittings are sized so that they cannot be improperly connected.

The bung assembly 52, including the attached wands, is constructed of stainless steel.

The pneumatically operated, stainless steel double diaphragm pump 13 transfers fluids from the collection container to the waste discharge drum. The diaphragms are made of TEFLON and the pump is self-priming. The pump can operate dry.

The various lines of the system of the invention are constructed to have a braided stainless steel exterior and TEFLON interior.

While the invention has been particularly shown and described with reference to preferred embodiments, it will be understood by those skilled in the art that various changes in form and detail may be made therein without departing from the spirit and scope of the invention. For example, the housing 16 could take various shapes and, in fact, is totally eliminated in one embodiment.

The accumulator 47 is constructed of stainless steel.

It is noted that the bung assembly 52, with its wands, provides the advantage of utilizing only one bung opening of the discharge drum 14 for inserting both the discharge wand 44 and the level-sensor wand 48 into the discharge drum 14; thus leaving the other bung opening free for other purposes. For example, the free bung opening can have a filter 76, as depicted in FIG. 2, mounted therein to treat vapors that are discharged while the drum is being filled. One can also inject chemicals into the discharge drum 14 through the free bung opening to neutralize or solidify the liquid waste contents thereof. The free bung port can also be used to sample the liquid waste as it is being consolidated in the discharge drum 14.

The diaphragm pump 18 is mounted on an isolation damper to reduce sound levels and to lessen vibration.

What is claimed:

1. A waste-liquid transfer apparatus for transferring waste liquid from a collection container to a discharge container comprises:
a collection line for insertion into the collection container for sucking the waste liquid from the collection container;
a discharge line for insertion into the discharge container for discharging the waste liquid into the discharge container;
a liquid pump connected to the collection line and the discharge line, said liquid pump being driven by pressurized gas;
a pressurized gas source for selectively applying pressurized gas to said liquid pump for driving said pump to suck said waste liquid through said collection line and discharge it through the said discharge line to thereby cause said waste liquid to flow from the collection container to said discharge container;
wherein is further included at least one auxiliary pressurized gas device for applying pressurized gas from said pressurized gas source to said waste liquid for further enhancing orderly transfer of said waste liquid from said collection container to said discharge container.

2. The waste-liquid transfer apparatus as in claim 1 wherein said pressurized gas source includes a manual start valve for applying said pressurized gas to said liquid pump for thereby driving said pump and for cutting off said pressurized gas to said liquid pump for stopping operation of said liquid pump.

3. The waste-liquid transfer apparatus as in claim 1 wherein said one auxiliary pressurized gas device includes at least a first auxiliary pressurized gas device that diverts pressurized gas from said pump through said collection line.

4. The waste-liquid transfer apparatus as in claim 3 wherein said collection line includes a strainer.

5. The waste-liquid transfer apparatus as in claim 4 wherein said collection line includes a rigid suction wand having a substantially-linear portion for being placed vertically in said collection container, and wherein said strainer is mounted in said substantially-linear portion of said wand.

6. The waste-liquid transfer apparatus as in claim 1 wherein said at least one auxiliary pressurized gas device injects pressurized gas into said discharge container through a level-sensor wand and monitors the gas pressure in said level-sensor wand to measure the level of waste liquid in said discharge container.

7. The waste-liquid transfer apparatus as in claim 6 wherein said at least one auxiliary pressurized gas device automatically reduces pressurized gas flowing to said gas-operated pump in response to a predetermined level of gas pressure in said level sensor wand.

8. The waste-liquid transfer apparatus as in claim 6 wherein said discharge container is a drum having two bung openings and said apparatus includes a bung for one of the bung openings having both said collection line and said level-sensor wand mounted thereon.

9. The waste-liquid transfer apparatus as in claim 6 wherein at least a second auxiliary pressurized gas device diverts pressurized gas from said pump through said collection line for flushing said collection line.

10. The waste-liquid transfer apparatus as in claim 9 wherein said collection line includes a strainer.

11. The waste-liquid transfer apparatus as in claim 10 wherein said collection line includes a substantially rigid, wand having a substantially-linear portion for being placed vertically in said collection container, and wherein said strainer is mounted in said substantially-linear portion.

12. The waste-liquid transfer apparatus as in claim 11 wherein said at least one auxiliary pressurized gas device automatically reduces pressurized gas flowing to said gas-operated pump in response to a predetermined level of waste liquid in said discharge container.

13. The waste-liquid transfer apparatus as in claim 1 wherein is further included an accumulator in said discharge line for smoothing flow of fluid passing through said discharge line.

14. The waste-liquid transfer apparatus as in claim 1 wherein is further included a housing in which said liquid pump is mounted.

15. The waste-liquid transfer apparatus as in claim 14 wherein said housing includes a holster for holding ends of said collection discharge lines when they are not inserted into collection and discharge containers.

16. The waste-liquid transfer apparatus as in claim 14 wherein said housing has two electrical grounding wires mounted thereon, one for being attached to a discharge container and the other for being attached to an electrical ground.

17. The waste-liquid transfer apparatus as in claim 14 wherein said housing is mounted on wheels to be rollable.

18. A waste-liquid transfer method for transferring waste liquid from a collection container to a disposable container including the steps of pumping said waste liquid from a collection container into a discharge container using a liquid pump that is driven by pressurized gas and otherwise applying auxiliary pressurized gas to said waste liquid for enhancing orderly transfer of said waste gas from said collection container to said discharge container.

19. The waste-liquid transfer method of claim 18 wherein the auxiliary pressurized gas is applied to said waste liquid for flushing a collection line between said pump and said collection container.

20. The waste-liquid transfer method of claim 18 wherein the auxiliary pressurized gas is applied to waste liquid in said discharge container for measuring the level of waste in said discharge container.
